(19) United States
(12) Patent Application Publication
(10) Pub. No.: US 2007/0005763 A1
(43) Pub. Date: Jan. 4, 2007

(54) Method and system for using load information in an instant messaging system

(75) Inventors: Shmuel Shaffer, Palo Alto, CA (US); Labhesh Patel, San Francisco, CA (US); Denise G. Caballero-McCann, Raleigh, NC (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/173,607

(22) Filed: Jul. 1, 2005

(51) Int. Cl. G06F 15/173

(52) U.S. Cl. 709/225

(57) ABSTRACT

A method for using load information in an instant messaging system includes determining current communication session load information of the user. The method includes blocking from transmission to the user instant message communications based on the current communication session load information of the user.

### TECHNICAL FIELD OF THE INVENTION

This invention relates in general to communication systems and, more particularly, to a method and system for using load information in an instant messaging system.

### BACKGROUND OF THE INVENTION

The field of communications has become increasingly important in today's society. In particular, the ability to quickly and effectively interact with an individual (through any suitable communications media) presents a significant obstacle for component manufacturers, system designers, and network operators. This obstacle is made even more difficult due to the plethora of diverse communication technologies (e.g. Instant Messaging, cellular communications, simple voice sessions, etc.) that exist in the current marketplace.

In some cases, call centers track communication sessions of its agents. The call centers may keep track of the number of phone calls and IM sessions an agent is handling at any given time. If the number of sessions that the agent handles exceeds a pre-determined number, the agent may be marked as “not available” which prevents the call center from transferring additional calls to the agent.

Instant messaging systems are gaining acceptance as a means for real time communication. Typically, a person may communicate in multiple instant messaging sessions at the same time. In many cases, a person may be inundated with many instant messaging messages by individuals who may not be aware of other sessions that the person may be handling. In addition, some existing systems allow users to mark themselves as busy.

### SUMMARY OF THE INVENTION

The present invention provides a method and system for using load information in an instant messaging system that substantially eliminates or reduces at least some of the disadvantages and problems associated with previous methods and systems.

In accordance with a particular embodiment, a method for using load information in an instant messaging system includes determining current communication session load information of the user. The method includes blocking from transmission to the user instant message communications based on the current communication session load information of the user.

Blocking from transmission to the user instant message communications based on the current communication session load information of the user may comprise blocking from transmission to the user instant message communications based on predefined communication session load limits of the user. The method may include receiving from the user the predefined communication session load limits of the user. Current communication session load information may comprise current instant messaging communication session load information and current phone communication session load information. Blocking from transmission to the user instant message communications based on the current communication session load information of the user may comprise presenting the user as unavailable for additional instant message communication sessions based on the current communication session load information of the user. The method may also include receiving from a sender an instant message communication for the user and an indication that the instant message communication is urgent. The method may include transmitting the instant message communication to the user based on the urgency of the instant message communication.

In accordance with another embodiment, a method for using load information in an instant messaging system includes receiving from a first user an instant message communication for a second user and determining current communication session load information of the second user. The method includes transmitting the current communication session load information to the first user and prompting the first user whether the first user desires to begin an instant messaging session with the second user. The method also includes, in response to the prompting, receiving an indication from the first user that the first user desires to begin an instant messaging session with the second user and transmitting the instant messaging communication to the second user.

Technical advantages of particular embodiments include the ability to prevent new instant messaging communication sessions from being established for a particular user based on the user's current communication session load. Thus, particular embodiments prevent users from being inundated by an excessive number of simultaneous IM sessions. Peer users may be provided with visibility of the number and/or type of communication sessions in which the target user is currently participating. In some cases, busy users may be automatically marked as such, and IM communications may be automatically prevented from reaching them when they are busy. Accordingly, particular embodiments can increase efficiencies of users since they may be prevented from wasting time associated with attempting to communicate with other users who are already busy with a plurality of communication sessions.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system including a plurality of endpoints operable to communicate among each other and a plurality of instant messaging servers, in accordance with a particular embodiment of the present invention;

FIG. 2 illustrates an instant messaging server of FIG. 1 in more detail, illustrating aspects of the present invention; and

FIG. 3 illustrates a method for using load information in an instant messaging system, in accordance with an embodiment of the present invention.

### DETAILED DESCRIPTION OF THE INVENTION

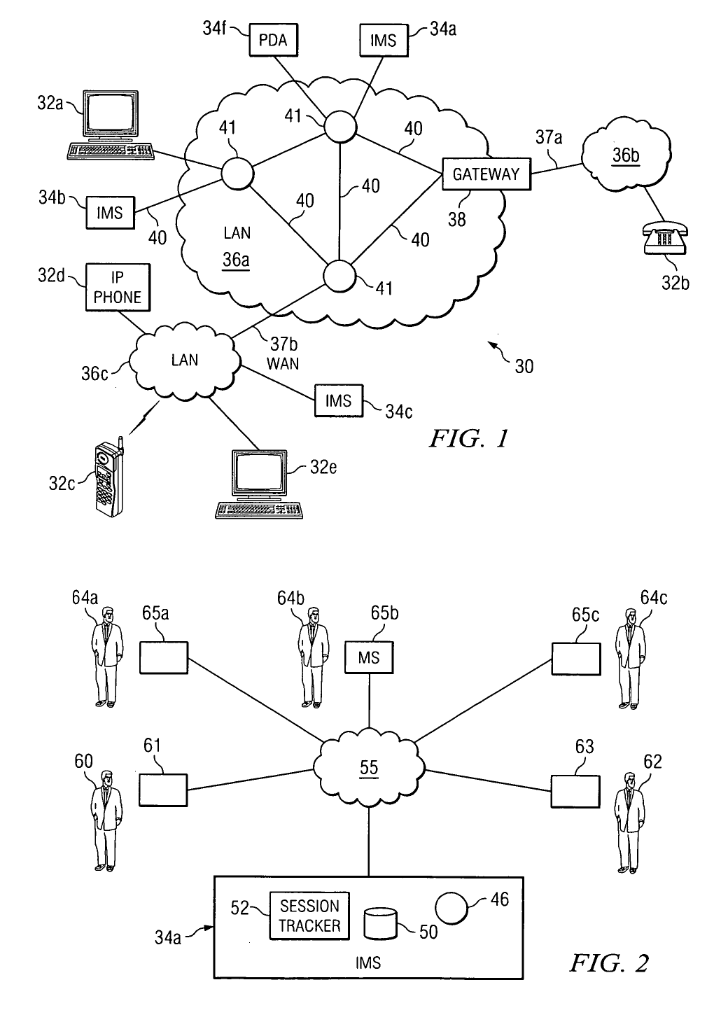

FIG. 1 illustrates a communication system 30 including a plurality of endpoints 32a-32f having the ability to establish instant messaging (IM) communication sessions between each other, using one or more of communication networks 36a-36c. Communication system 30 includes IM servers (IMSs) 34a-34c that facilitate IM communications, such as the communication of text messages, between endpoints 32a-32f. IM allows user to form a list of people with whom they wish to communicate, such as a “buddy list.” Typically, users may communicate with anyone on their buddy list who is on-line at the time. IM servers 34a-34c process messages, such as text messages, between endpoints 32a-32f.

In particular embodiments, IM servers utilize communication session load information for users to provide the ability to prevent new instant messaging communication sessions from being established for a particular user based on the user's current communication session load. In addition, users desiring to send IM communications may be informed of an intended recipient's heavy communication load so that the senders may have an option to reconsider in light of the heavy load. In some cases, busy users may be automatically marked as such, and IM communications may be automatically prevented from reaching them when they are busy.

In the illustrated embodiment, communication network 36a is a local area network (LAN) that enables communication between a plurality of endpoints 32a-32f and IMSs 34a-34c distributed across multiple cities and geographic regions. In another embodiment, a single, central IMS may be used, which facilitates IM communication sessions between endpoints distributed across multiple cities and geographic regions. Communication network 36b is a public switched telephone network (PSTN) and couples endpoint 32b with communication network 36a through gateway 38. Communication network 36c is another LAN, which couples endpoints 32c, 32d and 32e and IMS 34c with communication network 36a. Accordingly, users of endpoints 32a-32f and IMSs 34a-34c can establish communication sessions between and among each network component coupled for communication with one or more of networks 36a-36c. Communication links 37a and 37b couple communication networks 36a and 36b, and communication networks 36a and 36c, respectively. In the illustrated embodiment, communication link 37b is a wide area network (WAN), which couples LANs 36a and 36c.

Communication network 36a includes a plurality of segments 40 and nodes 41 that couple endpoints 32a and 32f with IMSs 34a and 34b, gateway 38 and communication networks 36b-36c. Therefore, a user of endpoint 32a is provided with access to endpoints 32b-32f, and IMS 34c. Nodes 41 may include any combination of network components, gatekeepers, call managers, conference bridges, routers, hubs, switches, gateways, endpoints, or other hardware, software, or embedded logic implementing any number of communication protocols that allow for the exchange of packets in communication system 30.

Although the illustrated embodiment includes three communication networks 36a-36c, the term “communication network” should be interpreted as generally defining any network capable of transmitting audio and/or video telecommunication signals, data, and/or messages, including signals, data or messages transmitted through text chat, instant messaging and e-mail. Any one of networks 36a-36c may be implemented as a local area network (LAN), wide area network (WAN), global distributed network such as the Internet, Intranet, Extranet, or any other form of wireless or wireline communication network. Generally, network 36a provides for the communication of packets, cells, frames, or other portions of information (generally referred to as packets herein) between endpoints 32a-32f. Communication network 36a may include any number and combination of segments 40, nodes 41, endpoints 32a-32f, and/or IMSs 34a-34c.

In a particular embodiment, communication network 36a employs communication protocols that allow for the addressing or identification of endpoints, nodes, and/or IMSs coupled to communication network 36a. For example, using Internet protocol (IP), each of the components coupled together by communication network 36a in communication system 30 may be identified using IP addresses. In this manner, network 36a may support any form and/or combination of point-to-point, multicast, unicast, or other techniques for exchanging media packets among components in communication system 30. Any network components capable of exchanging audio, video, or other data using frames or packet, are included within the scope of the present invention.

Network 36a may be directly coupled to other IP networks including, but not limited to, another LAN or the Internet. Since IP networks share a common method of transmitting data, telecommunication signals may be transmitted between telephony devices located on different, but interconnected, IP networks. In addition to being coupled to other IP networks, communication network 36a may also be coupled to non-IP telecommunication networks through the use of interfaces or components, for example gateway 38. In the illustrated embodiment, communication network 36a is coupled with PSTN 36b through gateway 38. PSTN 36b includes switching stations, central offices, mobile telephone switching offices, pager switching offices, remote terminals, and other related telecommunications equipment that are located throughout the world. IP networks transmit data (including voice and video data) by placing the data in packets and sending each packet individually to the selected destination, along one or more communication paths. Unlike a circuit-switched network (like PSTN 36b), a dedicated circuit is not required for the duration of a call or fax transmission over IP networks.

In particular embodiments, communication system 30 may receive and transmit data in a session initiation protocol (SIP) environment. SIP is an application-layer control protocol that includes primitives for establishing, modifying and terminating communication sessions. SIP works independently of underlying transport protocols and without dependency on the type of session that is being established. SIP also transparently supports name mapping and redirection services, which support personal mobility.

It will be recognized by those of ordinary skill in the art that endpoints 32a-32f, IMSs 34a-34c and/or gateway 38 may be any combination of hardware, software, and/or encoded logic that provides communication services to a user. For example, endpoints 32a-32f may include a telephone, a personal computer (PC), a video monitor, an IP phone, a cell phone, a personal digital assistant (PDA) or any other communication hardware, software and/or encoded logic that supports the communication of packets of media (or frames) using communication network 36a. Endpoints 32a-32f may also include unattended or automated systems, gateways, other intermediate components or other devices that can establish media sessions. Although FIG. 1 illustrates a particular number and configuration of endpoints, IMSs, segments, nodes, and gateways, communication system 30 contemplates any number or arrangement of such components for IM communications.

FIG. 2 illustrates IMS 34a in more detail, in accordance with a particular embodiment of the present invention. In the illustrated embodiment, IMS 34a includes a processor 46, memory module 50, and a session tracker 52. Processor 46 may be a microprocessor, controller, or any other suitable computing device, resource, or combination of hardware, software and/or encoded logic. Processor 46 may work in conjunction with other components of IMS 34a to provide functionality of IMS 34a discussed herein.

Memory module 50 may be any form of volatile or non-volatile memory including, without limitation, magnetic media, optical media, random access memory (RAM), read-only memory (ROM), removable media, or any other suitable local or remote memory component. Memory module 50 may store any suitable information necessary to accomplish the IMS functionality described herein, such as user communication load information and session load limits and operational instructions associated with users, as further discussed below.

Session tracker 52 monitors or otherwise keeps track of current communication sessions, whether IM, phone or otherwise, in which various users are participating and may be any combination of hardware, software and/or encoded logic. In some cases, session tracker 52 may work with a call manager, presence server or other component to keep track of current communication sessions of users. For example, a call manager may maintain information on users of communication system 30 and may facilitate communication among users. In particular embodiments, a call manager may maintain a listing, table, or other organization of information about users. The information may include a name or other identifier for user and contact information such as phone numbers and email addresses for the users. A presence server may be used to detect and monitor the presence of users communicating within communication system 30. A presence server may include a single computer or a group of computers that are capable of detecting the presence and current communication session of a user at an endpoint associated with the user. Examples of presence servers include presence servers as defined by IETF specifications.

Endpoints 61, 63 and 65 may be similar to one or more of the endpoints described above with respect to FIG. 1, such as PCs, PDAs, IP phones and cellular phones. In the illustrated embodiment, endpoints 61, 63 and 65 are coupled to each other and to IMS 34a through a communication network 55, which may comprise one or more communication networks such as the communication networks described above with respect to FIG. 1.

As indicated above, in particular embodiments IM server 34a tracks the number of communication sessions in which a particular user is participating. The communication sessions tracked by the IM server may include various IM or chat sessions, phone sessions (e.g., cellular, PSTN, IP phone or otherwise) and any other type of communication session.

As an example in operation, user 60 of endpoint 61 attempts to establish an IM communication session with user 62 of endpoint 63. User 62 is already communicating on three other IM sessions, with users 64a-64c of endpoints 65a-65c, respectively. Session tracker 52 of IMS 34a keeps track of existing communication sessions and their respective participants and endpoints. As indicated above, these existing communication sessions may include more than just IM sessions. Phone and other types of communication sessions of participants may be tracked to monitor each participants' current communication session load.

As user 60 attempts to send an IM message to user 62, IMS 34a (e.g., through its processor 46) notifies user 60 (e.g., through a display or other interface of endpoint 61, that user 62 is already handling three communication sessions. In some cases IMS 34a may identify the particular type of communication sessions that user 62 is currently handling (e.g., IM communication sessions in this example). In some embodiments, IMS 34a may give user 60 an option of continuing to establish an IM communication session with user 62 despite the current IM load of user 62. User 60 may indicate his preference using any suitable interface or method. In this case, if user 60 indicated to proceed with the establishment of an IM communication session with user 62, then IMS 34a would not prevent the IM message from reaching user 62. If, however, user 60 did not wish to proceed with the IM session with user 62 given the current communication load of user 62, then IMS 34a (e.g., through its processor) would prevent the IM message from reaching user 62.

In particular embodiments, IMS 34a may operate under instructions associated with user 62 regarding the establishment of new IM sessions given the user's current communication load. These instructions may direct IMS 34a to prevent the establishment of new IM sessions for the user under certain communication session load circumstances, such as a particular number and/or type of communication sessions in which user 62 is currently participating. For example, instructions may direct that no new IM sessions be begun for user 62 if the user is currently communicating in X number of IM sessions, Y number of phone sessions and/or Z number of total communication sessions. In some cases, according to the instructions, IMS 34a may present user 62 to other users as currently “unavailable” for new IM communications given a particular communication session load for user 62. In addition to presenting the user as unavailable, IMS 34a may present current communication session load information of user 62 to other users in particular cases. Instructions associated with the user may dictate that only certain users may receive current communication session load information for user 62. Instructions discussed herein that control functionality of an IMS for a particular user may change dynamically according to a particular schedule or occurrence of event(s) or may change based on with whom the user is currently communicating. In addition, instructions may be received from user 62 or may be set by a system administrator or operator. For example, user 62 may be presented with configuration screens where the user may enter thresholds regarding his ability to handle a plurality of sessions simultaneously.

In some cases, a user 60 attempting to establish an IM session with user 62 may be given the option of proceeding, despite a currently heavy communication session load of user 62, only if user 60 certifies or otherwise verifies that the IM message of user 60 is urgent. Otherwise, as indicated above, IMS 34a may prevent any attempted IM communications from reaching an endpoint of user 62. In some embodiments, when an IMS prevents an attempted IM communication from reaching an endpoint of its intended recipient, the IMS may notify the sender, through any suitable means, that his communication has been blocked. In addition, the IMS may store the IM communication, for example in memory module 50, for future delivery to its intended recipient when the communication session load of the intended recipient is reduced.

As indicated above, in some cases an IMS exposes to potential senders of IM communications a particular user's communication load information, particularly when a sender has attempted to transmit a message to a busy user. However, in some cases, a user's communication session load information may be displayed or otherwise presented to other users before the other users transmit IM communications (e.g., so that the other users may decide beforehand whether to try and establish an IM communication session with the user whose load information is presented). As indicated above, this presentation may only be made to particular potential users (e.g., high ranking or high priority users) based on instructions associated with the user whose load information is presented or otherwise.

It will be recognized by those of ordinary skill in the art that IMS 34a is merely one example configuration of an IMS for using load information in accordance with particular embodiments. IMS 34a may include any number of interfaces, processors, memory modules and session trackers to accomplish the functionality and features described herein. For example, although IMS 34a is illustrated and described as including processor 46, memory module 50 and session tracker 52, these components and other desired components for performing the above described functionality may be centrally located (local) with respect to one another, or distributed throughout communication system 30. In addition, one or more components of IMS 34a may work together in performing various functionality described herein. Moreover, IMS 34a may work with other network components, such as a call manager or a presence server, to perform various functionality described herein.

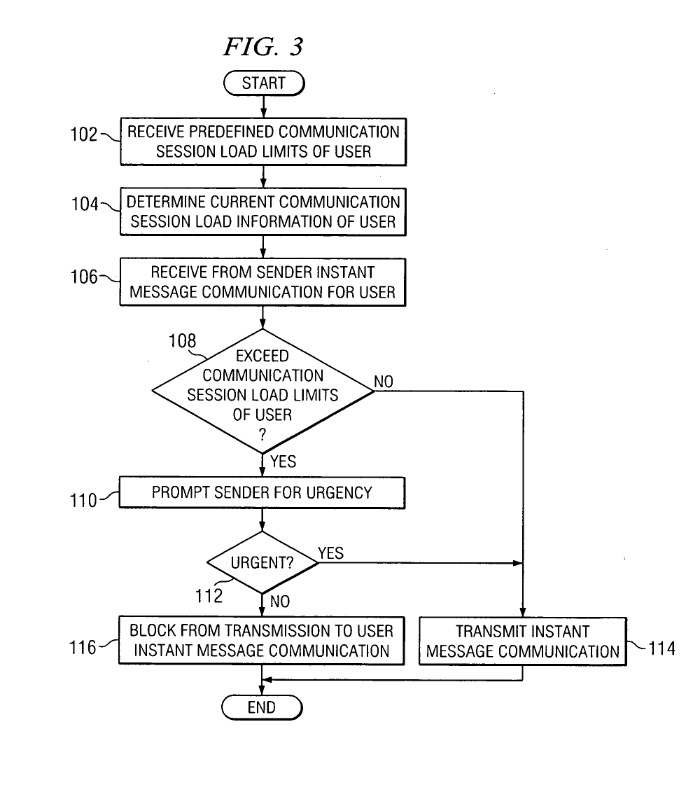

FIG. 3 is a flowchart illustrating a method for using load information in an instant messaging system, in accordance with a particular embodiment. The method begins at step 102 where predefined communication session load limits of a user are received. The communication session load limits may relate to any particular type of communication session of the user, such as IM or phone communication sessions. The load limits may be received in instructions from the user or from a system administrator or operator. In particular cases, the load limits may depend on a particular time, event or other circumstance such as particular persons (e.g., high ranking or high priority persons or otherwise) involved in communication sessions of the user.

At step 104, current communication session load information of a user is determined. For example, using presence or otherwise, an IMS may determine the number and type of communication sessions in which the user is currently participating. At step 106, an instant message for a user is received from a sender. In some cases, the instant message may actually be received at an IMS. However, it should be understood that in some cases such receipt may be satisfied by an IMS or other component determining that the sender attempted to send an IM communication to the user.

At step 108, it is determined whether the communication session load limits of the user would be exceeded with the establishment of a new IM communication session resulting from transmission of the IM communication received from the sender. If the communication session load limits of the user would not be exceeded with the establishment of a new IM communication session, then the method proceeds to step 114 where the IM communication received from the sender is transmitted to the user.

If the communication session load limits of the user would be exceeded with the establishment of a new IM communication session, then the sender of the IM communication may be prompted at step 110 to indicate whether the IM communication is urgent. Such prompt and indication from the sender regarding whether the IM communication may be performed using any suitable interface or method.

At step 112, it is determined, based on the sender's response to the urgency prompt, whether the IM communication from the sender is urgent. If the IM communication is urgent, then the method proceeds to step 114 where the IM communication is transmitted to the user. If, however, the IM communication for the user from the sender is not urgent, then the method proceeds to step 116 where the IM communication is blocked or otherwise prevented from being transmitted to the user. Such blocking or prevention may be accomplished in any suitable manner, depending on system architecture and configuration. For example, if IM communications typically must pass through an IMS before being transmitted to an intended recipient, then the IMS may simply block the IM communication from reaching the user. In some cases, an IMS may control other network components to prevent the IM communication that the sender attempted to send from reaching the user. In some embodiments, when the IM communication attempted to be transmitted by a sender is blocked or otherwise prevented from transmission to its intended recipient, the sender is notified of such occurrence. In some cases, the IM communication may be saved for future delivery as the communication session load on the recipient is reduced.

While the flowchart of FIG. 3 focuses on the situation where a sender actually attempts to send an IM communication to a user, as indicated above in some cases blocking IM communications from a user whose communication session load limits are met may merely comprise presenting the user as unavailable. Such presentation may be made to all users (e.g., all potential senders of IM communications) or to a particular subset of users depending on user type or other user, system or situational characteristic.

In addition, as indicated above in some cases when a sender attempts to send an IM communication to a user an IMS may then present to the sender the user's current communication load information and may ask the sender whether the sender desires to continue with the transmission of the IM communication based on the user's current communication session load information. In some cases, only particular senders may be entitled to receive current communication session load information of a user based on instructions associated with the user or the system.

Some of the steps illustrated in FIG. 3 may be combined, modified or deleted where appropriate, and additional steps may also be added to the flowchart. Additionally, steps may be performed in any suitable order without departing from the scope of the invention.

As indicated above, technical advantages of particular embodiments include the ability to prevent new instant messaging communication sessions from being established for a particular user based on the user's current communication session load. Thus, particular embodiments prevent users from being inundated by an excessive number of simultaneous IM sessions. Peer users may be provided with visibility of the number and/or type of communication sessions in which the target user is currently participating. A peer user attempting to establish an IM session may be alerted that the intended IM recipient is busy. In some cases, only urgent incoming IM communications may be allowed to reach the intended recipient. The system may automatically mark busy users as such and may prevent messages from reaching such busy users. The system may preserve the privacy of users by preventing their status from being exposed to others. In addition, the system may provide a means for partially blocking the user's load. With this feature, the user's current communication session load information may be presented only to a selected group of users based on instructions associated with the user.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within communication system 30 and IMS 34a, these elements may be combined, rearranged or positioned in order to accommodate particular routing architectures or needs. In addition, any of these elements may be provided as separate external components to communication system 30, IMS 34a or each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for using load information in an instant messaging system, comprising:
determining current communication session load information of the user; and
blocking from transmission to the user instant message communications based on the current communication session load information of the user.

2. The method of claim 1, wherein blocking from transmission to the user instant message communications based on the current communication session load information of the user comprises blocking from transmission to the user instant message communications based on predefined communication session load limits of the user.

3. The method of claim 2, further comprising receiving from the user the predefined communication session load limits of the user.

4. The method of claim 1, wherein the current communication session load information comprises current instant messaging communication session load information.

5. The method of claim 4, wherein the current communication session load information comprises current phone communication session load information.

6. The method of claim 1, wherein blocking from transmission to the user instant message communications based on the current communication session load information of the user comprises presenting the user as unavailable for additional instant message communication sessions based on the current communication session load information of the user.

7. The method of claim 1, further comprising:
receiving from a sender:
an instant message communication for the user; and
an indication that the instant message communication is urgent; and
transmitting the instant message communication to the user based on the urgency of the instant message communication.

8. The method of claim 1, further comprising notifying each sender of the instant message communications that the sender's respective instant message communication was blocked and will be subsequently transmitted to the user when a communication session load of the user is reduced.

9. The method of claim 1, further comprising storing the instant message communications for subsequent transmission to the user.

10. A method for using load information in an instant messaging system, comprising:
receiving from a first user an instant message communication for a second user;
determining current communication session load information of the second user;
transmitting the current communication session load information to the first user;
prompting the first user whether the first user desires to begin an instant messaging session with the second user;
in response to the prompting, receiving an indication from the first user that the first user desires to begin an instant messaging session with the second user; and
transmitting the instant messaging communication to the second user.

11. The method of claim 10, wherein the current communication session load information comprises current instant messaging communication session load information.

12. The method of claim 11, wherein the current communication session load information comprises current phone communication session load information.

13. The method of claim 10, further comprising:
receiving instructions associated with the second user, the instructions indicating users who may receive communication session load information of the second user; and
before transmitting the current communication session load information to the first user, determining that the first user may receive the current communication session load information of the second user based on the instructions associated with the second user.

14. The method of claim 10, wherein the current communication session load information is transmitted to the first user before receiving from a first user an instant message communication for a second user.

15. A system for using load information in an instant messaging system, comprising a processor operable to:
determine current communication session load information of the user; and
block from transmission to the user instant message communications based on the current communication session load information of the user.

16. The system of claim 15, wherein a processor operable to block from transmission to the user instant message communications based on the current communication session load information of the user comprises a processor operable to block from transmission to the user instant message communications based on predefined communication session load limits of the user.

17. The system of claim 16, further comprising an interface coupled to the processor and operable to receive from the user the predefined communication session load limits of the user.

18. The system of claim 15, wherein the current communication session load information comprises current instant messaging communication session load information.

19. The system of claim 18, wherein the current communication session load information comprises current phone communication session load information.

20. The system of claim 15, wherein a processor operable to block from transmission to the user instant message communications based on the current communication session load information of the user comprises a processor operable to present the user as unavailable for additional instant message communication sessions based on the current communication session load information of the user.

21. The system of claim 15:
further comprising an interface coupled to the processor and operable to receive from a sender:
an instant message communication for the user; and
an indication that the instant message communication is urgent; and
wherein the processor is further operable to transmit the instant message communication to the user based on the urgency of the instant message communication.

22. The system of claim 15, wherein the processor is further operable to notify each sender of the instant message communications that the sender's respective instant message communication was blocked and will be subsequently transmitted to the user when a communication session load of the user is reduced.

23. The system of claim 15, wherein the processor is further operable to store the instant message communications for subsequent transmission to the user.

24. A system for using load information in an instant messaging system, comprising:
an interface operable to receive from a first user an instant message communication for a second user;
a processor coupled to the interface and operable to:
determine current communication session load information of the second user;
transmit the current communication session load information to the first user; and
prompt the first user whether the first user desires to begin an instant messaging session with the second user;
the interface operable to, in response to the prompting, receive an indication from the first user that the first user desires to begin an instant messaging session with the second user; and
the processor operable to transmit the instant messaging communication to the second user.

25. The system of claim 24, wherein the current communication session load information comprises current instant messaging communication session load information.

26. The system of claim 25, wherein the current communication session load information comprises current phone communication session load information.

27. The system of claim 24, wherein:
the interface is further operable to receive instructions associated with the second user, the instructions indicating users who may receive communication session load information of the second user; and
the processor is further operable to, before transmitting the current communication session load information to the first user, determine that the first user may receive the current communication session load information of the second user based on the instructions associated with the second user.

28. A system for using load information in an instant messaging system, comprising:
means for determining current communication session load information of the user; and
means for blocking from transmission to the user instant message communications based on the current communication session load information of the user.

29. A system for using load information in an instant messaging system, comprising:
means for receiving from a first user an instant message communication for a second user;
means for determining current communication session load information of the second user;
means for transmitting the current communication session load information to the first user;
means for prompting the first user whether the first user desires to begin an instant messaging session with the second user;
means for, in response to the prompting, receiving an indication from the first user that the first user desires to begin an instant messaging session with the second user; and
means for transmitting the instant messaging communication to the second user.

30. Logic embodied in a computer readable medium, the computer readable medium comprising code operable to:
determine current communication session load information of the user; and
block from transmission to the user instant message communications based on the current communication session load information of the user.

31. Logic embodied in a computer readable medium, the computer readable medium comprising code operable to:
receive from a first user an instant message communication for a second user;
determine current communication session load information of the second user;
transmit the current communication session load information to the first user;
prompt the first user whether the first user desires to begin an instant messaging session with the second user;
in response to the prompting, receive an indication from the first user that the first user desires to begin an instant messaging session with the second user; and
transmit the instant messaging communication to the second user.
